(19) United States
(12) Patent Application Publication
(10) Pub. No.: US 2005/0081075 A1
(43) Pub. Date: Apr. 14, 2005

(54) Computer system, carrier medium and method for adjusting an expiration period

(76) Inventors: Andrej Kocev, Lunenburg, MA (US); Jeff Wilcox, Chelmsford, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/685,028

(22) Filed: Oct. 14, 2003

(51) Int. Cl. G06F 1/04

(52) U.S. Cl. 713/501

(57) ABSTRACT

A system, carrier medium and method for adjusting an expiration period are provided herein. In one embodiment, the system includes a timing logic unit coupled to produce a predetermined number of pulses in response to a transaction request transmitted from a source device to a target device coupled within or external to the system. In general, the timing logic unit is configured to generate a time expired signal upon producing a last one of the predetermined number of pulses. The system may also include a processor for executing program instructions configured to programmably alter a rate at which the predetermined number of pulses are produced by the timing logic unit. In this manner, the system is configured to adjust an expiration period for completing a transaction cycle associated with the transaction request.

### BACKGROUND

1. Field of the Invention

The present invention generally relates to computer systems, and more particularly, to a means for adjusting an expiration period associated with a transaction cycle, which is conducted between source and target devices arranged within or coupled to a computer system.

2. Background Information

Computer systems generally include a plurality of devices interconnected by one or more buses. For example, conventional computer systems typically include a Central Processing Unit (“CPU”), which is coupled to an external memory device (e.g., a “main memory” device) through a bridge logic unit. A memory interface, or memory controller, is therefore incorporated within the bridge logic unit for generating various control signals used to access the memory device. An interface to a high bandwidth local expansion bus, such as a Peripheral Component Interconnect (“PCI”) bus, may also be included within the bridge logic unit. Examples of peripheral devices that may be coupled to the PCI bus include network interface cards, video accelerators, audio cards, SCSI adapters, telephony cards, etc. A full description of the PCI bus architecture can be found in the PCI Local Bus Specification Revision 2.1, which is available from the PCI Special Interest Group and hereby incorporated by reference. In addition to bus architecture, the PCI Local Bus Specification defines a specific set of protocols, including signal timing requirements for various transactions conducted over the PCI bus.

In some cases, an older-style expansion bus may be supported through another bus interface to provide compatibility with earlier-version expansion bus adapters. Examples of such expansion buses include the Industry Standard Architecture (“ISA”) bus, also referred to as the AT bus, the Extended Industry Standard Architecture (“EISA”) bus, and the Microchannel Architecture (“MCA”) bus. Various peripheral devices may be coupled to this second expansion bus, including a fax/modem card, sound card, etc.

In applications that are graphics intensive, the bridge logic unit may support an additional peripheral bus optimized for graphics related transfers. A popular example of such a bus is the Advanced Graphics Port (“AGP”) bus. The AGP bus is generally considered a high performance, component level interconnect optimized for three dimensional graphical display applications, and is based on a set of performance enhancements to the PCI bus specifications. In general, AGP bus specifications provide faster data transfer rates. A display device, such as a cathode ray tube (“CRT”) or a liquid crystal display (“LCD”), is a typical example of an AGP peripheral device.

Since computer systems were originally developed for computationally simple applications (e.g., word processing, spreadsheet applications, etc.), the bridge logic unit within these systems was optimized to provide the CPU with relatively good performance with respect to its access to main memory. Unfortunately, the bridge logic unit provided relatively poor performance with respect to main memory accesses by peripheral devices residing on the various peripheral buses (such as, e.g., PCI, ISA, EISA, MCA or AGP buses). The bridge logic unit also provided relatively poor performance with respect to data transfers between the CPU and the peripheral devices, as well as between peripheral devices interconnected through the bridge logic unit.

Recently, computer systems have been increasingly utilized in computationally intensive applications, such as the processing of various real time applications, including multimedia applications (e.g., video, audio, telephony, and speech recognition). Not only do these systems require that the CPU have adequate access to the main memory, they also require fair memory access for peripheral devices residing on the various peripheral buses. As such, it is often important that transactions between the CPU, main memory and the various peripheral buses be handled efficiently.

It would, therefore, be desirable to provide a simple and low-cost means for optimizing system efficiency and performance with respect to data transfers between various system components.

### BRIEF SUMMARY

The problems noted above are solved in large part by a system, method and carrier medium for adjusting an expiration period. In one embodiment, the system may include a timing logic unit coupled to produce a predetermined number of pulses in response to a transaction request transmitted from a source device to a target device associated with the system. In general, the timing logic unit is configured to generate a time expired signal upon producing a last one of the predetermined number of pulses. The system may also include a processor for executing program instructions configured to programmably alter a rate at which the predetermined number of pulses are produced by the timing logic unit. In this manner, the system may be configured to adjust an expiration period for completing a transaction cycle associated with the transaction request.

In a specific embodiment, the system may be a computer system including a source device, which is configured to initiate a transaction cycle by sending a transaction request to a target device. A timing logic unit may be arranged within the target device. In most cases, the timing logic unit may include a time register for storing a predetermined expiration value, and a first counter (otherwise referred to herein as a “pulse counter”) for receiving a number of pulses corresponding to the predetermined expiration value and generating a time expired signal upon receipt of a last one of the number of pulses. In a preferred embodiment, the computer system includes a memory device for storing program instructions configured to programmably alter a rate at which the number of pulses are received by the first counter, thereby adjusting an expiration period for completing the transaction cycle.

In another embodiment, a method is provided herein for adjusting an expiration period for completing a transaction cycle conducted between source and target devices within a system. In some cases, the method may include extending the expiration period, where the step of extending includes receiving interrupt signals at a processor of the system. The interrupt signals are generated at a fixed rate by a clock source of the system. Subsequently, the method may include altering a pulse rate of a timing logic unit of the system by enabling the timing logic unit to generate a pulse every n^{th} time the processor receives an interrupt signal, where ‘n’ is a programmable value selected from a group consisting of any positive, non-zero integer value.

In yet another embodiment, a computer-usable carrier medium is provided herein. In general, the computer-usable carrier medium may include first program instructions executable on a computer system for enabling a timing logic unit of the computer system to generate one or more pulses, and second program instructions executable on the computer system for repeating the first program instructions upon receiving every n^{th} interrupt signal at a processor of the computer system. As noted above, ‘n’ is preferably a programmable value selected from a group consisting of any positive, non-zero integer value. In this manner, the second program instructions may be executed to increase or decrease an expiration period for completing a transaction cycle conducted between source and target devices coupled within or to the computer system.

### BRIEF DESCRIPTION OF THE DRAWINGS

For a detailed description of the embodiments of the invention, reference will now be made to the accompanying drawings in which:

FIG. 1 is a block diagram illustrating one embodiment of a system that may benefit from adjusting an expiration period associated with a transaction cycle;

FIG. 2 is a block diagram illustrating one embodiment of a timing logic unit;

FIG. 3 is a block diagram illustrating exemplary components within the “Time Out” Logic included within the timing logic unit of FIG. 2;

FIG. 4 is a timing diagram comparing one example of an original expiration period, which may occur during a delayed read cycle, with exemplary expiration periods that have been extended to allow the delayed read cycle to be completed;

FIG. 5 is a timing diagram comparing one example of an original expiration period, which may occur during a delayed read cycle, with exemplary expiration periods that have been reduced to optimize a time period set aside for completing the delayed read cycle; and

FIG. 6 is a state diagram illustrating an exemplary algorithm by which an expiration period can be extended or reduced.

While the invention is susceptible to various modifications and alternative forms, specific embodiments thereof are shown by way of example in the drawings and will herein be described in detail. However, the drawings and detailed description thereto are not intended to limit the invention to the particular form disclosed, but on the contrary, the intention is to cover all modifications, equivalents and alternatives falling within the spirit and scope of the present invention as defined by the appended claims.

### Notation and Nomenclature

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

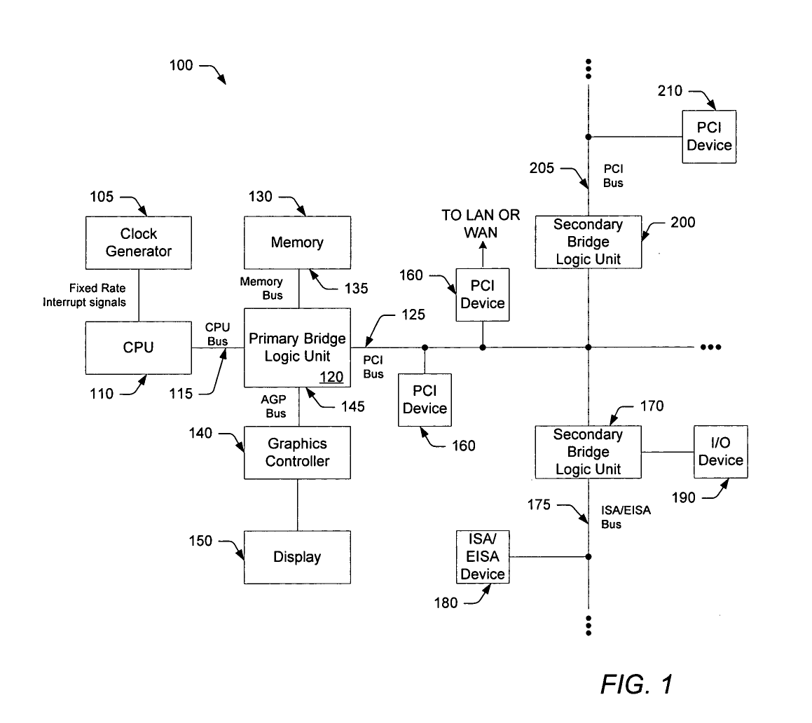

Turning now to FIG. 1, computer system 100 generally includes CPU 110, which is coupled to a variety of system components through primary bridge logic unit 120. Primary bridge logic unit 120 may be otherwise referred to as a “host bus bridge”. Communication between CPU 110 and primary bridge logic unit 120 is conducted over CPU bus 115. In addition to CPU 110, primary bridge logic unit 120 is generally coupled to main memory 130 through memory bus 135, and to one or more PCI devices 160 through PCI bus 125. In some embodiments, graphics controller 140 may also be coupled to primary bridge logic unit 120 through AGP bus 145. In this manner, primary bridge logic unit 120 is configured to coordinate transactions between CPU 110, main memory 130, and one or more of the peripheral devices indirectly or directly coupled to primary bridge logic unit via PCI bus 125 and/or AGP bus 145.

Computer system 100 may, in some embodiments, include one or more secondary bridge logic units, thereby providing an electrical interface to devices residing on additional peripheral buses. In one example, secondary bridge logic unit 170 is included within computer system 100 to provide an interface between primary bridge logic unit 120, via PCI bus 125, and one or more ISA or EISA devices 180 through EISA/ISA bus 175. As such, secondary bridge logic unit 170 may be referred to as a “PCI-to-EISA/ISA bridge”. In addition to providing an interface to EISA/ISA bus 175, secondary bridge logic unit 170 may incorporate other functionalities, as desired. In one embodiment, for example, an input/output controller (not shown) may be coupled external to, or integrated within, secondary bridge logic unit 170 to provide operational support for various input/output (“I/O”) devices 190 (e.g., a keyboard, a mouse, etc.) and/or for various serial or parallel ports. In some cases, I/O devices 190 may be additionally or alternatively coupled to an I/O controller external to, or integrated within, graphics controller 140. Secondary bridge logic unit 170 may further incorporate a disk drive controller, an interrupt controller and/or power management support functionalities, as desired.

As noted above, computer system 100 may, in some cases, include more than one secondary bridge logic unit. In one example, secondary bridge logic unit 200 may be included within computer system 100 to provide an interface between primary bridge logic unit 120, via PCI bus 125, and additional PCI devices 210 through PCI bus 205. As such, secondary bridge logic unit 200 may be referred to as a “PCI-to-PCI bridge”. In this manner, secondary bridge logic units 170 and 200 may additionally function to provide an interface to PCI devices 160, EISA/ISA devices 180, I/O devices 190. Similar to secondary bridge logic unit 170, secondary bridge logic unit 200 may incorporate other functionalities, as desired. In some cases, for example, secondary bridge logic unit 200 may additionally or alternatively incorporate some, if not all, of the other functionalities described above for secondary bridge logic unit 170.

CPU 110 is typically a microprocessor, and more specifically, may include multiple microprocessors. However, one of ordinary skill in the art would recognize that CPU 110 is not limited solely to microprocessors, and may comprise any number and/or any configuration of processing devices appropriate for a given system and/or for a given application executable on that system. In some cases, a cache memory device (not shown) may be integrated within CPU 110 and/or externally coupled to CPU 110 through CPU bus 115.

Main memory 130 is a memory device in which data and program instructions are stored. A suitable main memory 130 comprises Dynamic Random Access Memory (“DRAM”), and preferably, a plurality of banks of Synchronous DRAM. Alternative types of memory could include RAMBUS. In most cases, CPU 110 executes the program instructions stored within main memory 130. However, CPU 110 may also execute program instructions stored within a cache memory device, which is internally or externally coupled to CPU 110. Suitable cache memory devices may include, for example, SDRAM.

PCI devices 160 and 210 may include various types of peripheral devices, such as network interface cards, video accelerators, audio cards, hard or floppy disk drives, Small Computer Systems Interface (“SCSI”) adapters, telephony cards, etc. In one embodiment, for example, at least one of PCI devices 160 and 210 comprises a network interface card for providing a wired or wireless connection between computer system 100 and a Local Area Network (“LAN”) and/or a Wide Area Network (“WAN”). Similarly, EISA/ISA devices 180 may include various types of peripheral devices, such as fax/modem card, sound card, etc. Other types of peripheral devices, which may be suitable for operating over a PCI bus, an EISA/ISA bus or any other peripheral bus, are generally well known in the art and applicable to the system described herein.

Graphics controller 140 may be provided within computer system 100 to control the rendering of text and images on display device 150. Display device 150 may be any electronic display upon which an image or text can be presented. A suitable display device 150 may include, for example, a cathode ray tube (“CRT”), a liquid crystal display (“LCD”), etc. In one embodiment, graphics controller 140 is a typical graphics accelerator generally known in the art for rendering three-dimensional data structures. As such, graphics controller 140 may have the ability to request and receive access to those data structures stored within main memory 130. In the embodiment of FIG. 1, data retrieval from main memory 130 is significantly increased by dedicating a high performance peripheral bus (i.e., the AGP bus) to the transactions conducted between graphics controller 140 and a target interface to main memory 130 (i.e., primary bridge logic unit 120). For certain operations, graphics controller 140 may be further configured to request and receive access to peripheral devices, such as PCI devices 160 and 210, EISA/ISA devices 180 and I/O devices 190. In an alternative embodiment, graphics controller 140 may be coupled as a PCI device rather than an AGP device.

As used herein, a “source” is a device that initiates a data transfer, or transaction, which is intended for a “target” device. Alternatively, the term “initiator” or “master” may be used to describe a source device, while a target device may be referred to as a “slave”. With regards to FIG. 1, substantially any device within computer system 100 is capable of both master and slave operation (with the exception of clock generator 105 and main memory 130). In most cases, data transactions between source and target devices are controlled by strict timing requirements, which are generally predefined by a specific set of protocols universally adopted for coordinating transactions over the various peripheral buses. These set of protocols are commonly referred to as “bus specifications”.

For example, a delayed transaction is one feature of the PCI bus protocol, which was introduced with Revision 2.1 of the PCI Local Bus Specification to optimize system efficiency and bus performance. As described herein, a “delayed transaction” is one that is implemented when a source initiates a transaction intended for a target, which either 1) cannot immediately respond, or 2) cannot complete the initial data phase of the transaction cycle within a timing requirement set by the system designer. In most cases, the timing requirement is usually chosen to correspond to a timing requirement determined by the PCI bus specification. Such a timing requirement may include a first time period—denoted in a maximum number of PCI clock cycles—extending between the start of a transaction cycle (i.e., upon assertion of a FRAME# signal by the source) and either 1) completion of the initial data phase of the transaction cycle (i.e., upon assertion of a TRDY# signal by the target), or 2) issuance of a retry or stop abort signal (i.e., upon assertion of a STOP# signal by the target). According to the PCI bus specification, most target devices are required to complete the initial data phase of a transaction cycle within 16 clock cycles from the beginning of the transaction. This first time period—otherwise referred to as the “target latency”—is extended to 32 clock cycles for primary bridge logic units. Any PCI target device that cannot meet the 16 or 32 cycle rule must terminate the current transaction cycle and retry the transaction as a delayed transaction operation.

A delayed transaction operation is generally carried out in three phases. First, a source initiates a transaction cycle by transmitting a transaction request to a target. If, for reasons noted above, the transaction request is to be completed as a delayed transaction, the target captures the information required to complete the transaction (e.g., address, command, etc.) and prompts the source to retry the transaction at a later time (i.e., as a delayed transaction). Next, the target proceeds to execute the transaction request and allocates internal storage space (e.g., buffer space within the target) for temporarily storing the transaction data, therein. Meanwhile, the source attempts to reissue the original transaction request by repeatedly re-arbitrating for access to the PCI bus. In most cases, the source is able to complete the transaction cycle after the transaction request is completed and the original request is successfully reissued. In this manner, delayed transactions can provide significant improvement in bus performance by freeing the bus to accommodate transactions between other devices, while the target fetches the transaction data.

As such, one or more components within computer system 100 are preferably configured to support delayed transaction operations. More specifically, any component directly or indirectly coupled to PCI bus 125 or to PCI bus 205 may be configured to support delayed transaction operations. AGP devices, for example, may also support delayed transaction operations. In addition, several types of transactions may be retried as delayed transactions; namely read and write operations to I/O, memory and configuration space, and interrupt acknowledges.

Though delayed transaction operations tend to improve bus performance, problems may occur when a delayed transaction cycle cannot be completed within another timing requirement set by the system designer. In most cases, the timing requirement is usually chosen to correspond to another timing requirement set by the PCI bus specification. Such a timing requirement may include a second time period—also denoted in a maximum number of PCI clock cycles—during which the buffer space may remain allocated within the target for receiving transaction data. In other words, the second time period may begin when a target accepts a transaction request (i.e., when the target captures the transaction request information after assertion of the FRAME# signal) and terminates the current transaction by prompting the source to retry the transaction as a delayed transaction. According to the PCI bus specification, the buffer space within the target may remain allocated for receiving and holding the transaction data for 2¹⁵ clock cycles.

However, a “time expired signal”—otherwise referred to as a “time-out signal”—may be sent to the CPU, or to some external device, if the delayed transaction cycle is not completed within the second time period predefined by the PCI bus specification. As such, the second time period is generally referred to herein as the “expiration period”. In response to a time expired signal, one of several actions may be taken depending on the type of delayed transaction requested (e.g., whether the transaction was a read or write to I/O, memory, or configuration space) and/or the reason for which the transaction “timed out” or expired (e.g., due to a “slow” source or target device).

In one embodiment, for example, a source may initiate a read transaction that must ultimately be retried as a delayed read transaction. In some cases, though the target is able to successfully retrieve the transaction data, the source fails to reissue the original transaction request before the end of the predefined expiration period. Upon receipt of the time expired signal, the transaction data may be discarded from the target, and the buffer space de-allocated in preparation for receiving other transaction data. This case is generally applicable to devices that perform speculative transactions (e.g., devices that request data, but don't return for it), and to various problems associated with slow source devices. In other cases, however, the source promptly reissues the original transaction request and waits for the target to complete the request (e.g., by asserting the TRDY# signal, if the target is a PCI device, thereby providing the transaction data to the source). If the target fails to complete the transaction request before the end of the predefined expiration period, the source may stop trying to reissue the request and signal an error event, or the target may abort the transaction cycle. Such a case is generally applicable to bridge logic units that suffer from undesirably long memory latency, and to other problems associated with slow target devices. Unfortunately, the problems encountered in either case tend to degrade system efficiency and bus performance.

Conventional system designers have suggested various means by which to solve the above problems. However, these solutions cannot optimize system efficiency and bus performance in all circumstances. In one example, the timer responsible for generating the time expired signal—generally referred to as the “discard timer”—is disabled to allow the transaction cycle to be completed. If, however, the discard timer is disabled to allow a “slow” target additional time for retrieving the transaction data, a source, which speculatively prefetches data, runs the risk of receiving “stale” data (i.e., incorrect data that leads to data corruption). In some cases, receipt of stale data may lead to undetected data corruption. On the other hand, a different problem may occur if the discard timer is disabled to allow a “slow” source additional time for reissuing the original transaction request. For example, a target generally comprises a finite amount of internal buffer space for storing transaction data. If the source fails to reissue the transaction request, for whatever reason, the transaction data retrieved by the target (in a delayed read transaction) may become locked within the target when all buffers are used and full. Without a way to clear the transaction data stored within the target, a deadlock may occur: the target waits for the initiating source to return and refuses to accept new transaction cycles. This solution is clearly inefficient and may, in some cases, lead to system failure.

Other conventional system designers have attempted to reprogram the predetermined “expiration value” (i.e., a value usually hardwired or stored to indicate the duration of the expiration period) as an alternative to disabling the discard timer. In most cases, the expiration value is predefined by the bus specification and represents the duration of the expiration period in units of clock cycles (e.g., 2¹⁵ clock cycles in the PCI bus specification). In some embodiments, the discard timer may include a time constant register for storing the expiration value and timing logic for generating the time expired signal if a transaction cycle is not completed within the predetermined expiration period. However, the predetermined expiration period may be extended, in some cases, by reprogramming the time constant register with a substantially larger expiration value, which allows the transaction cycle to be completed. Unfortunately, hardware constraints placed on the time constant register (e.g., the number of bits initially allocated to storing the expiration value) significantly limit the programmable expiration values to a specific set of values. The maximum programmable expiration value is also limited by these hardware constraints. This solution, therefore, provides limited flexibility and may not, in all cases, provide the appropriate expiration value.

Consequently, it would be beneficial to provide an improved means by which to adjust an expiration period set aside for completing a transaction cycle, or a portion thereof. Preferably, such means would provide a low-cost solution to the problems described above, and therefore, would not require additions or changes to existing hardware components within a system. In other words, the solution described herein may substantially eliminate the additional time and cost typically associated with redesigning hardware components during the test and debug phase of manufacture.

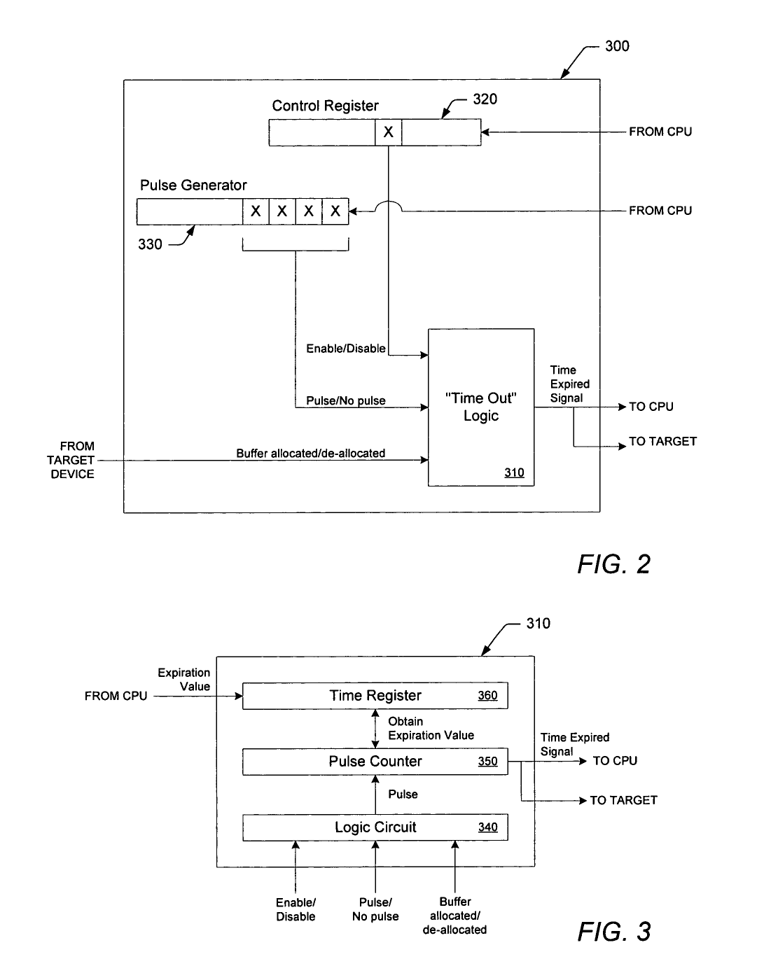

FIG. 2 is a block diagram illustrating a timing logic unit (300), or discard timer, according to a preferred embodiment of the present invention. In general, timing logic unit 300 may be included within any system device capable of either master or slave operation. In the computer system of FIG. 1, for example, timing logic unit 300 may be included within any device other than clock generator 105, main memory 130, display device 150, and I/O devices 190. More specifically, timing logic unit 300 may be included within at least one of primary bridge logic unit 120, secondary bridge logic units 170 and 200, graphics controller 140, PCI devices 160 and 210, and ISA/EISA devices 180. In some cases, a source or target device may be configured for tracking more than one expiration period. As such, a separate timing logic unit may be included within one or more internal components of the source or target device. Alternatively, multiple logic circuits 310 may be included within a single timing logic unit 300 in order to track multiple expiration periods associated with either the source or target device.

In one embodiment, timing logic unit 300 includes circuit 310 (labeled “Time Out” Logic in FIG. 2), control register 320 and pulse generator 330. In general, control register 320 and pulse generator 330 comprise substantially any read/write-able storage device. Preferably, pulse generator 330 is a counter that allows programmable reconfiguration (i.e., one that allows software to read/write configuration bits and/or data to the counter). For purposes of this discussion, pulse generator 330 may also be referred to as a “second counter” within timing logic unit 300. In some cases, control register 320 may comprise a programmable register.

In this manner, control register 320 functions to store an enable/disable signal, which may be received from CPU 110 of FIG. 1. More specifically, control register 320 allocates one or more bits for either storing an “enable” signal (e.g., as a logic “1” or high value), or for storing a “disable” signal (e.g., as a logic “0” or low value). It is understood, however, that the enable/disable signal may alternatively be represented by logic values opposite to those provided above, or represented by multi-bit logic values. As shown in FIG. 2, the enable/disable signal is provided to circuit 310; thus, values chosen to represent the enable/disable signal may depend only on the logic included within circuit 310.

Pulse generator 330 functions to generate a pulse/no pulse signal based on inputs received from CPU 110 of FIG. 1. In other words, pulse generator 330 allocates one or more bits for either generating a “pulse” signal (e.g., a bit string of all 1s) or for generating a “no pulse” signal (e.g., any bit pattern other than the bit pattern chosen for the “pulse” signal). It is understood, however, that the particular bit patterns chosen to represent the pulse/no pulse signal are dependent only on the logic included within circuit 310, and thus, are not limited to the examples provided herein. In some cases, the number of bits (b) used to determine the pulse/no pulse signal is programmable for allowing a user or system designer to alter the rate at which the pulses are generated. If 3 bits are used to determine the pulse/no pulse signal, for example, a pulse will be generated once every 2³=8 clocks; if 4 bits are used, a pulse will be generated once every 2⁴=16 clocks, etc.

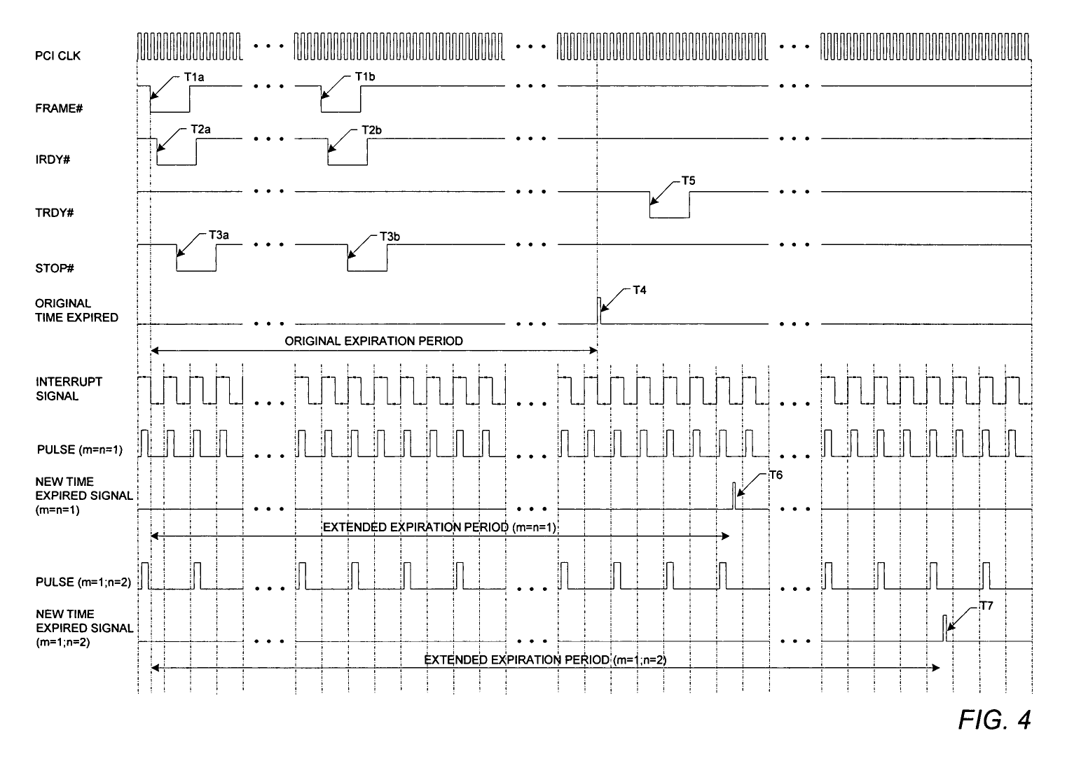

FIG. 3 is a block diagram illustrating exemplary components within circuit 310. In one embodiment, circuit 310 includes logic circuit 340, pulse counter 350 and time register 360. In addition to receiving enable/disable signal from control register 320 and pulse/no pulse signal from pulse generator 330, logic circuit 340 is further configured to receive a buffer allocated/de-allocated signal from a target device. (Note: the embodiment shown in FIG. 3 assumes circuit 310 is included within a target device. In the case circuit 310 is included within a source device, the “buffer allocated/de-allocated” signal name may be replaced by a “request-in-progress/not-in-progress” signal.) In other words, logic circuit 340 may receive a “buffer allocated” signal (e.g., a logic “1” or high value) after a target device accepts a transaction request from an initiating source and allocates buffer space for receiving transaction data corresponding to the request. On the other hand, logic circuit 340 may receive a “buffer de-allocated” signal (e.g., a logic “0” or low value) from the intended target if the buffer space is subsequently de-allocated for whatever reason (e.g., if the transaction terminates normally, if either the source or target is unable to complete the transaction before the end of the expiration period, if the transaction is aborted, etc.). Similar to the signals described above, the logic values chosen to represent the buffer allocated/de-allocated signal are dependent only on the logic included within circuit 310, and thus, are not limited to the examples provided herein.

As such, logic circuit 340 may include one or more logic elements for generating a pulse upon receiving an enable signal from control register 320, a pulse signal from pulse generator 330, and a buffer allocated signal from a target device associated with the current transaction. In one embodiment, logic circuit 340 comprises a logical AND for generating a pulse upon receiving all 1's from the inputs coupled to logic circuit 340. It is understood, however, that logic circuit 340 could include substantially any sequential or combinatorial logic capable of generating a pulse when a certain set of conditions are met (e.g., upon receiving an enable signal from control register 320, a pulse signal from pulse generator 330, and a buffer allocated signal from the target device).

As shown in FIG. 3, pulse counter 350 is configured for receiving the pulse generated by logic circuit 340. Upon receiving the pulse, pulse counter 350 may either 1) increment a value stored therein to indicate a current number of pulses received, or 2) decrement the value to indicate a remaining number of pulses to be received. As such, pulse counter 350 may be configured to generate and send a “time expired signal” to CPU 110 upon receiving a last one of a predetermined number (N) of the pulses from logic circuit 340. As used herein, the predetermined number, N, may be otherwise referred to as the “expiration value”. As noted above, the expiration value may be preset by the system designer (usually in accordance with the bus specification) to indicate the maximum allowable duration for a particular expiration period.

In some cases, the predetermined expiration value may be stored within time register 360 during system initialization (i.e., during system startup). In other cases, however, it may be beneficial to provide a user with the ability to modify the expiration value after system initialization. As such, time register 360 is preferably a programmable register, which is configured to receive the predetermined expiration value (or a subsequently modified expiration value) from CPU 110. In this manner, pulse counter 350 may obtain the predetermined expiration value from time register 360. Though time register 360 is illustrated as external to pulse counter 350 in FIG. 3, time register 360 may alternatively be a configuration register within pulse counter 350. In any case, pulse counter 350 is preferably a programmable counter similar to pulse generator 330. In an alternative embodiment, the predetermined expiration value may be hardwired within circuit 310, thereby eliminating the need for a programmable means of storing the expiration value, such as programmable time register 360. As such, time register 360 may or may not be included within circuit 310, especially if pulse generator 330 is configured to programmably adjust the rate of the pulse/no pulse signal.

Instead of reprogramming the expiration value to adjust an insufficient expiration period, as described above, timing logic unit 300 is preferably configured to alter the rate at which pulse counter 350 receives the predetermined number of pulses from logic circuit 340. As will be described in more detail below, substantially any expiration period duration is attainable by altering the pulse rate within timing logic unit 300. An exemplary system and method for altering the pulse rate may be further described in reference to FIGS. 1 and 4-6.

In some embodiments, computer system 100 of FIG. 1 may be configured for adjusting an expiration period in accordance with the present invention. As shown in FIG. 1, CPU 110 is generally coupled to receive fixed rate interrupt signals from clock generator 105. As used herein, these fixed rate interrupt signals may also be referred to as interval-timer interrupt (“ITI”) signals. In one embodiment, clock generator 105 comprises a counter and interval timer chip (“CIT”), which is configured to receive and count up to (or down from) a preset number of clock signals. These clock signals may originate from a system clock or a local clock. Upon receiving a last one of the preset number of clock signals, clock generator 105 may generate an interval-timer interrupt signal (which is sent to CPU 110) and restart the counting process. The fixed rate at which the interrupt signals are sent to the CPU is generally dependent on the operating frequency of the device supplying the clock signals (e.g., the system clock, local clock etc.).

In a specific example, clock generator 105 sends one interrupt signals to CPU 110 every 0.001 seconds (assuming, e.g., an interval-timer interrupt rate of 1000 interrupts per second). In terms of a PCI clock frequency (F_{PCI}), an interrupt signal may be generated and sent after every (F_{PCI}/1000) PCI clock pulses. It is understood, however, that other rates are entirely possible and within the scope of the invention. In an alternative embodiment, clock generator 105 may comprise any other device capable of generating a fixed rate signal.

CPU 110 is normally configured to execute a set of program instructions—collectively referred to as an “interval timer routine”—each time an interval-timer interrupt signal is received from clock generator 105. In a preferred embodiment of the present invention, another set of program instructions are appended to those within the interval timer routine. In most cases, the set of program instructions and the additional program instructions are stored within a memory device, such as main memory 130. Alternatively, the set of program instructions and the additional program instructions may be stored within a memory device (not shown) local to CPU 110. As will be described in more detail below, an expiration period may be adjusted with almost infinite flexibility by executing the additional program instructions every n^{th} time (i.e., where n is a programmable value selected from any positive, non-zero integer value) CPU 110 receives an interrupt signal from clock generator 105.

FIGS. 4-6 illustrate an exemplary method by which the additional program instructions may be used to adjust an expiration period. In some cases, it may be beneficial to extend an expiration period. In one example, shown in the timing diagram FIG. 4, the expiration period might be extended to allow a “slow” target additional time for retrieving the transaction data requested during a delayed read cycle conducted over a PCI bus. In such an example, a source may initiate a transaction cycle by transmitting a transaction request to a target. Let's assume that PCI device 160 (e.g., a network interface card) is a source that wishes to gain access to main memory 130. In such an example, PCI device 160 may transmit a read request to primary bridge logic unit 120 (i.e., the target). According to the rules of PCI bus arbitration, a source may initiate a transaction request by asserting the FRAME# signal, as shown at time T1a in FIG. 4.

Now, assuming the read request is to be completed as a delayed transaction, the current transaction is terminated with retry by the target. The target then proceeds to execute the transaction request and allocates internal buffer space for storing read data retrieved from main memory 130. Next, a determination is made as to whether the target and source devices are ready to complete the transaction cycle. For purposes of this discussion, a source may assert a “source-ready signal” when the source is ready to complete a transaction cycle by sending or receiving transaction data corresponding to a transaction request of the transaction cycle. Similarly, a target may assert a “target-ready signal” upon completion of the transaction request (e.g., upon providing the transaction data to the source, in the embodiment of a delayed read transaction).

In the embodiment of FIG. 4, the source repeatedly re-issues the transaction request with assertion of the IRDY# signal (e.g., at times T2a and T2b). If the target is unable to retrieve the data from memory in a timely manner (e.g., before the original expiration period at time T4), the target may repeatedly terminate the transaction request with a retry (i.e., by asserting the STOP# signal at times T3a and T3b) until the target is ready to complete the transaction cycle (e.g., after it obtains the requested read data). As shown in FIG. 4, the target is ready to complete the transaction cycle upon assertion of the TRDY# signal at time T5. In such a case, it may be beneficial to extend the original expiration period to allow the delayed read cycle to be completed in a normal manner.

As shown in FIG. 4, the original expiration period is usually dependent on a system clock or a local clock. In such an example, the original expiration period may be determined by generating a predetermined number of pulses, N, in response to the clock pulses received by CPU 110. As described above in reference to FIGS. 2 and 3, the predetermined number of pulses may be generated by pulse generator 330 within timing logic unit 300. Since pulse generator 330 is a programmable counter, a number of bits (b) may be set aside within the pulse generator for generating a pulse upon reaching a count of approximately 2^{b} PCI clock pulses. In this manner, the original expiration period may be substantially equal to [(N*2^{b})/F_{PCI}], where F_{PCI} is the PCI clock frequency.

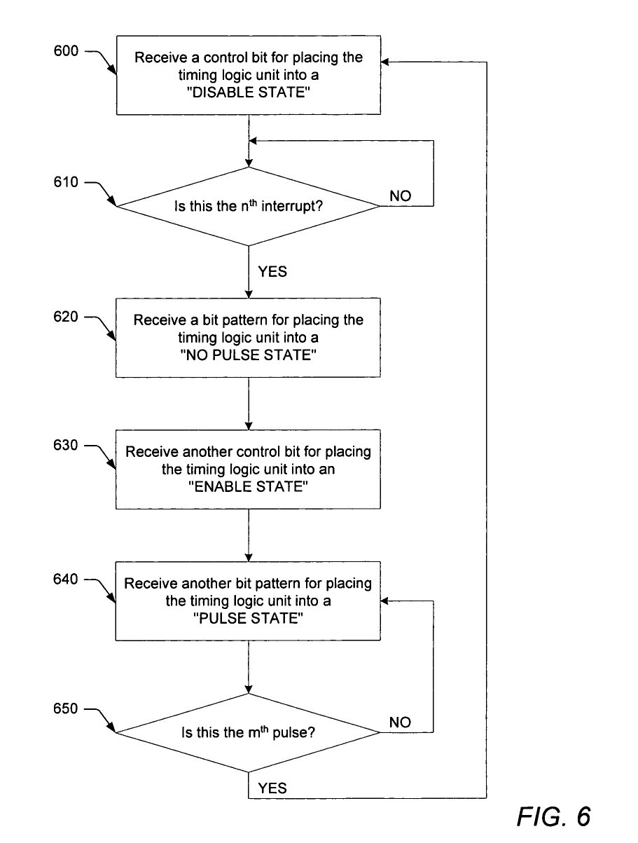

In a preferred embodiment, the original expiration period may be extended by generating a predetermined number of pulses in response to the fixed rate interval-timer interrupt signals received by CPU 110. Thus, instead of receiving clock pulses, pulse generator 330 may be configured to generate a pulse signal for every interval-timer interrupt signal received by CPU 110. The manner in which the pulses are generated by pulse generator 330 is described in more detail below with reference to FIG. 6. Generally speaking, however, a new expiration period may be generated by altering the pulse rate of pulse generator 330. In the current example, the new expiration period may be substantially equal to the predetermined number of pulses divided by the fixed rate of the interval-timer interrupt, or N/(fixed rate). Consequently, the original expiration period may be extended by a factor of [F_{PCI}/(fixed rate*2^{b})] by generating just one of the predetermined number of pulses in response to every interval-timer interrupt signal received by the CPU. This case is illustrated in FIG. 4 with a new expiration period extending between times T1a and T6. By extending the expiration period in such a manner, the present method allows the transaction cycle to be completed without the ill effects of a timeout condition.

In some cases, however, it may be beneficial to extend the original expiration period by a factor, which is greater (or less) than approximately [F_{PCI}/(fixed rate*2^{b})]. As such, a method is provided herein for programmably altering a rate at which the predetermined number of pulses are generated within timing logic unit 300. As will be described below, such a method may adjust the expiration period by executing an additional set of program instructions every n^{th} time a processor receives an interval-timer interrupt signal from a clock source. Thus, the original expiration period may be adjusted by a factor of [(n*F_{PCI})/(fixed rate*2^{b})]. As noted above, the additional set of program instructions are appended to the existing interval timer routine in accordance with the present invention.

In most cases, the method begins by receiving interval-timer interrupt signals at a processor (e.g., CPU 110 of FIG. 1) of a system, where the interrupt signals are generated at a fixed rate by a clock source (e.g., clock generator 105) of the system. In some cases, the method may alter a pulse rate within a timing logic unit (e.g., timing logic unit 300) of the system by enabling the timing logic unit to generate a pulse every n^{th} time an interrupt signal is received by the processor. In a preferred embodiment, ‘n’ is a programmable value selected from a group consisting of any positive, non-zero integer value. As such, the value ‘n’ may be one of the possible variables contained within the additional program instructions. Since any number of programming languages may be used to write the program instructions, an exemplary algorithm for altering the pulse rate is described below in reference to FIG. 6.

In step 600 of FIG. 6, the timing logic unit is disabled upon receiving and storing a control bit (denoted below as a “second control bit value”) from the processor. The processor will begin to execute the additional program instructions upon receiving the n^{th} interrupt signal (step 610 of FIG. 6). In step 620 of FIG. 6, the timing logic unit is initialized (i.e., placed into a ‘no pulse’ state) upon receiving a first bit pattern from the processor. This first bit pattern corresponds to the “no pulse” signal stored within pulse generator 330 of FIG. 2. In some cases, the “no pulse” may be designated as any bit pattern other than the bit pattern chosen to designate the “pulse” signal. In other cases, however, the “no pulse” signal may be only an incremental value away from the “pulse signal”, thereby causing the free-running counter within pulse generator 330 to be as far as possible from generating a pulse.

Next, the timing logic unit is enabled (i.e., placed into an ‘enable’ state) upon receiving a first control bit value from the processor (step 630 of FIG. 6). This first control bit value corresponds to the “enable” signal (e.g., a logic “1” or high value) stored within control register 320 of FIG. 2. In step 640 of FIG. 6, the timing logic unit is configured to generate a pulse (i.e., placed into a ‘pulse’ state) upon receiving a second bit pattern from the processor, where the second bit pattern is different from the first bit pattern. This second bit pattern corresponds to the “pulse” signal (e.g., a bit string of all 1's) stored within pulse generator 330. In some embodiments, the timing logic unit may be disabled (i.e., placed into a ‘disable’ state) after a pulse is generated and a second control bit value—different from the first control bit value—is received from the processor (e.g., if m=1 in step 650 of FIG. 6). This second control bit value corresponds to the “disable” signal (e.g., a logic “0” or low value) stored within control register 320. In this manner, a predetermined number of these pulses may be generated by re-executing the additional set of program instructions every n^{th} time an interrupt signal is received by the processor.

If ‘n’ is substantially equal to 1, the algorithm of FIG. 6 may cause a pulse to be generated for every interrupt signal received by the processor. As such, a new time expired signal may be generated by the timing logic unit (e.g., at time T6 of FIG. 4) after the additional program instructions are executed a number of times equal to the predetermined number, N. Thus, the algorithm may decrease the pulse rate of the timing logic unit to a rate substantially equal to the fixed rate generated by clock generator 105. As a consequence, the original expiration period may be extended to encompass a new expiration period arranged, for example, between times T1a and T6 of FIG. 4.

To extend the original expiration period by a substantially greater amount, an integer value greater than 1 may be programmably selected to represent ‘n’. For example, ‘n’ may be programmably selected to generate one pulse for every other interrupt signal (i.e., n=2) received by the processor. As such, a new time expired signal may be generated by the timing logic unit (e.g., at time T7 of FIG. 4) after the additional programs instructions are executed a number of times equal to the predetermined number. In such an example, the pulse rate of the timing logic unit may be further decreased to a rate, which is slower than the fixed rate by a factor of 1/n=1/2. As a consequence, the original expiration period may be extended to encompass a new expiration period arranged, for example, between times T1a and T7 of FIG. 4.

To extend the original expiration period by a slightly lesser amount, timing logic unit 300 may be configured to generate ‘m’ number of pulses for every n^{th} interrupt signal received by the processor. In general, ‘m’ and ‘n’ are programmable values selected from a group consisting of any positive, non-zero integer value. To extend the expiration period, however, ‘m’ is preferably an integer value less than the predetermined number, N, while ‘n’ is preferably an integer value greater than ‘m’. As such, a new time expired signal (not shown) may be generated by the timing logic unit after the additional programs instructions are executed a number of times equal to the predetermined number divided by ‘m’. Thus, the pulse rate of the timing logic unit may be decreased to a rate, which is slower than the fixed rate by a factor of m/n, where ‘n’ is substantially greater than ‘m’. The manner by which the ‘m’ number of pulses are generated will be described in more detail below.

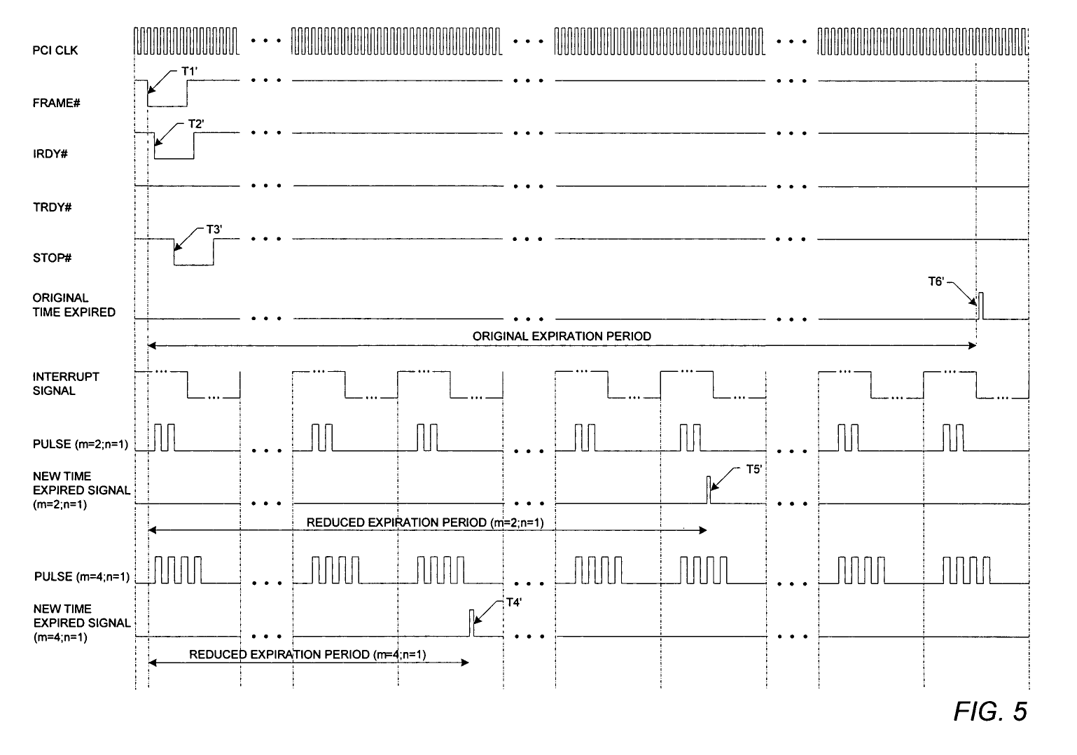

In some cases, it may be beneficial to reduce an expiration period, as shown in the timing diagram FIG. 5. In one example, the expiration period might be reduced to optimize a time period set aside for completing a transaction cycle, or a portion thereof. In another example, however, the expiration period for an upstream device may be reduced to ensure that it is substantially shorter than the expiration period for a downstream device. As used herein, a “downstream device” may be a device that is dependent on information from an “upstream device”. Though the original expiration period may be reduced, in some cases, by reprogramming time register 360 with a substantially shorter expiration value, this solution alone may not provide the appropriate expiration value in all cases.

Instead of reprogramming the expiration value to adjust an excessive expiration period, timing logic unit 300 is preferably configured to adjust the rate at which pulse counter 350 receives the predetermined number of pulses from logic circuit 340. The method described above for extending an expiration period may be adapted for reducing an expiration period. Returning to the above example, if the target is ready to complete the transaction cycle (in this case, a delayed read transaction), but the source is not, the buffer space within the target will be de-allocated in preparation for receiving other transaction data.

As shown in FIG. 5, for example, the transaction request may be terminated and retried with assertion of the STOP# signal at time T3′. In some cases, the source may fail to retry the transaction (e.g., if the source performs speculative prefetching and decides that it no longer needs the data it requested) before the end of the original expiration period at time T6′. Such a case is illustrated in FIG. 5 with the de-assertion of the FRAME# and IRDY# signals after times T1′ and T2′, respectively. The original expiration period may be reduced to allow the target to de-allocate the buffer sooner if it is clear that the source does not intend to return for the data. Thus, the expiration period may be reduced to improve bus performance.

Preferably, the original expiration period is reduced by programmably altering the rate at which the predetermined number of pulses are generated by timing logic unit 300. Similar to the method for slightly extending the expiration period, the expiration period may be reduced by enabling the timing logic unit to generate ‘m’ number of pulses for every n^{th} interrupt signal received by the processor. In general, ‘m’ and ‘n’ are programmable values selected from a group of any positive, non-zero integer value. To reduce the expiration period, however, ‘m’ is preferably an integer value less than the predetermined number, N, while ‘n’ is preferably an integer value less than ‘m’. In this manner, the predetermined number of pulses may be generated at a programmable rate, which is faster than the fixed rate by a factor of m/n, where ‘n’ is substantially less than ‘m’.

Likewise, the algorithm of FIG. 6 may be adapted to increase (rather than decrease) the programmable rate by generating a plurality of pulses in step 640. In other words, the expiration period may be reduce by placing the timing logic unit into the ‘pulse’ state multiple times (until the m^{th} pulse is generated by the timing logic unit in step 650 of FIG. 6) for each repetition through steps 600-650 of FIG. 6. The number of pulses generated in step 640 are determined by the value selected for ‘m’. In the embodiment of FIG. 5, for example, two pulses (i.e., m=2) are generated for each interrupt signal (i.e., n=1) received by the processor. As such, a new time expired signal may be generated by the timing logic unit (e.g., at time T5′ of FIG. 5) after the algorithm steps are repeated a number of times equal to the predetermined number divided by ‘m’. Thus, the pulse rate of the timing logic unit may be increased to a rate, which is substantially faster than the fixed rate by a factor of 2. As a consequence, the original expiration period may be reduced to a new expiration period arranged, for example, between times T1′ and T5′ of FIG. 5.

A larger value of ‘m’ may be selected to reduce the original expiration period by a substantially greater amount. For example, ‘m’ may be programmably selected to generate four pulses (i.e., m=4) for each interrupt signal (i.e., n=1) received by the processor. As such, a new time expired signal may be generated by the timing logic unit (e.g., at time T4′ of FIG. 5) after the algorithm steps are repeated a number of times equal to the predetermined number divided by ‘m’. In such an example, the pulse rate of the timing logic unit may be further increased to a rate, which is faster than the fixed rate by a factor of 4. As a consequence, the original expiration period may be reduced to a new expiration period arranged, for example, between times T1′ and T4′ of FIG. 5.

It is understood, however, that values of ‘m’ and ‘n’ other than those provided in the embodiments of FIGS. 4 and 5 could be equally applied to the algorithm of FIG. 6. Since the value of ‘n’ is limited only to positive, non-zero integer values, the present method provides almost infinite flexibility for adjusting an insufficient or excessive expiration period. In other words, substantially any expiration period duration is attainable by using the present method to programmably alter the pulse rate within the timing logic unit. In an alternative embodiment, the flexibility of the present invention may be further enhanced by modifying the expiration value stored within time register 360, in addition to programmably altering the pulse rate.

A computer-usable carrier medium is provided herein as a further embodiment of the present invention. In general, the computer-usable carrier medium may be configured for storing the additional program instructions and/or for storing the results obtained from executing the additional program instructions. As such, the computer-usable carrier medium may comprise a memory device, such as main memory 130. In some embodiments, the computer-usable carrier medium may be further configured for transferring information associated with a transaction cycle conducted between source and target devices external to, or integrated within, a computer system. In some cases, for example, the computer-usable carrier medium may comprise one or more buses within the computer system. In such an example, the source and target devices may be arranged within the computer system. In other cases, however, the computer-usable carrier medium may comprise a wired or wireless network interface for coupling the computer system to one or more additional systems. In this manner, a source device of the computer system may communicate with a target device arranged within one of the additional systems (or vice versa).

Therefore, a low-cost solution is provided herein for a problem that typically arises in computer systems having a hierarchy of “time out” or expiration values for tracking the progress of a transaction as it passes through multiple devices in the system. The solution enables the time out values to be tuned precisely by programmably altering the rate at which the time out signal corresponding to the expiration value is generated. In this manner, a system failure leading to a timeout condition can be easily isolated to the device for which the time out occurred. As described above, the present solution overcomes the disadvantages of prior art solutions limited by hardware constraints that do not allow the expiration value to be adjusted to the correct value.

The above discussion is meant to be illustrative of the principles and various embodiments of the present invention. Numerous variations and modifications will become apparent to those skilled in the art once the above disclosure is fully appreciated. For example, the expiration period is described above in terms of one timing characteristic set by the PCI bus specification; namely the amount of time allocated to completing a delayed read transaction cycle, which is conducted over a PCI bus between source and target devices coupled thereto. However, one of ordinary skill in the art would understand how the present system and method could be applied to any source or target device that must complete an operation within a certain time frame. For example, the present method may function to adjust 1) PCI timing characteristics other than those associated with delayed read transactions, 2) timing characteristics set by other bus specifications (such as AGP), 3) timing characteristics between computer systems connected over a network, etc. In addition, one of ordinary skill in the art would recognize how the present method could be applied to systems other than the computer system of FIG. 1. It is therefore intended that the following claims be interpreted to embrace all such variations and modifications.

1. A system, comprising:
a timing logic unit coupled to produce a predetermined number of pulses in response to a transaction request transmitted from a source device to a target device, wherein the timing logic unit is configured to generate a time expired signal upon producing a last one of the predetermined number of pulses; and
a processor for executing program instructions configured to programmably alter a rate at which the predetermined number of pulses are produced by the timing logic unit, thereby adjusting an expiration period for completing a transaction cycle associated with the transaction request.

2. The system as recited in claim 1, wherein the program instructions are configured to programmably decrease the rate for increasing the expiration period.

3. The system as recited in claim 1, wherein the program instructions are configured to programmably increase the rate for decreasing the expiration period.

4. The system as recited in claim 1, wherein the timing logic unit is arranged within at least one of the source and target devices.

5. The system as recited in claim 4, further comprising a carrier medium configured to transfer information associated with the transaction cycle between the source device and the target device.

6. The system as recited in claim 5, wherein the carrier medium comprises one or more buses within a computer system, such that the source and target devices are each arranged within the computer system.

7. The system as recited in claim 5, wherein the carrier medium comprises a wired or wireless network interface for coupling the system to one or more additional systems, such that the source device is arranged within the system and the target device is arranged within one of the additional systems, or vice versa.

8. A computer system, comprising:
a source device configured to initiate a transaction cycle by sending a transaction request to a target device;
a timing logic unit arranged within the target device, wherein the timing logic unit comprises:
a time register for storing a predetermined expiration value;
a first counter for receiving a number of pulses corresponding to the predetermined expiration value, and generating a time expired signal upon receipt of a last one of the number of pulses; and
a memory device for storing program instructions configured to programmably alter a rate at which the number of pulses are received by the first counter, thereby adjusting an expiration period for completing the transaction cycle.

9. The computer system as recited in claim 8, wherein the program instructions are configured to programmably decrease the rate, thereby increasing the expiration period, if a target-ready signal is not asserted by the target device before the time expired signal is generated by the timing logic unit.

10. The computer system as recited in claim 8, wherein the program instructions are configured to programmably increase the rate, thereby decreasing the expiration period, if a target-ready signal and a source-ready signal are asserted by the target device and the source device, respectively, before the time expired signal is generated by the timing logic unit.

11. The computer system as recited in claim 9, wherein the target-ready signal is asserted upon completion of the transaction request by the target device, and wherein the source-ready signal is asserted when the source device is ready to send or receive transaction data, which corresponds to the transaction request, for completing the transaction cycle.

12. The computer system as recited in claim 10, wherein the target-ready signal is asserted upon completion of the transaction request by the target device, and wherein the source-ready signal is asserted when the source device is ready to send or receive transaction data, which corresponds to the transaction request, for completing the transaction cycle.

13. The computer system as recited in claim 8, further comprising a processor coupled for receiving interrupt signals from a clock source at a fixed rate and for executing the program instructions in response to the interrupt signals.

14. The computer system as recited in claim 13, wherein the timing logic unit further comprises:
a control register for storing an enable signal;
a second counter for generating the number of pulses; and
a circuit comprising the time register and the first counter, wherein the circuit is coupled to receive the enable signal and at least one of the number of pulses every n^{th} time the processor receives an interrupt signal, wherein ‘n’ is a programmable value selected from a group consisting of any positive, non-zero integer value.

15. The computer system as recited in claim 14, further comprising a primary bus bridge logic unit configured to coordinate transactions between the processor, the memory device, and one or more peripheral devices coupled to the primary bus bridge logic unit over one or more peripheral buses of the computer system.

16. The computer system as recited in claim 15, wherein the timing logic unit is arranged within the primary bus bridge logic unit.

17. The computer system as recited in claim 15, wherein the timing logic unit is arranged within the one or more peripheral devices.

18. The computer system as recited in claim 15, further comprising a secondary bus bridge unit coupled to the primary bus bridge unit over one of the peripheral buses and having one or more additional peripheral devices coupled thereto, wherein the timing logic unit is arranged within the secondary bus bridge unit and/or within the one or more additional peripheral devices.

19. A method for adjusting an expiration period for completing a transaction cycle conducted between source and target devices within a system, the method comprising:
extending the expiration period to allow the transaction cycle to be completed, wherein said extending comprises:
receiving interrupt signals at a processor of the system, wherein the interrupt signals are generated at a fixed rate by a clock source of the system; and
altering a pulse rate of a timing logic unit of the system by enabling the timing logic unit to generate a pulse every n^{th} time the processor receives an interrupt signal, wherein ‘n’ is a programmable value selected from a group consisting of any positive, non-zero integer value.

20. The method as recited in claim 19, wherein said altering extends the expiration period by producing a predetermined number of pulses at a programmable rate, which is slower than the fixed rate by a factor of 1/n.

21. The method as recited in claim 20, wherein said altering a pulse rate comprises:
receiving a first bit pattern from the processor to place the timing logic unit into a ‘no pulse’ state;
receiving a first control bit from the processor to place the timing logic unit into an ‘enable’ state;
receiving a second bit pattern, which differs from the first bit pattern, from the processor to place the timing logic unit into a ‘pulse’ state; and
receiving a second control bit, which differs from the first control bit, from the processor to place the timing logic unit into a ‘disable’ state.

22. The method as recited in claim 21, wherein the steps associated with said altering a pulse rate are repeated a number of times equal to the predetermined number.

23. The method as recited in claim 19, further comprising:
reducing the expiration period, wherein said reducing comprises:
receiving interrupt signals at the processor, wherein the interrupt signals are generated at the fixed rate by the clock source; and
altering a pulse rate of the timing logic unit by enabling the timing logic unit to generate ‘m’ number of pulses every n^{th} time the processor receives an interrupt signal, wherein ‘m’ and ‘n’ are programmable values selected from a group consisting of any positive, non-zero integer value.

24. The method as recited in claim 23, wherein ‘m’ is selected from a group consisting of any positive, non-zero integer value less than the predetermined number, and wherein ‘n’ is selected from a group consisting of any positive, non-zero integer value less than ‘m’.

25. The method as recited in claim 24, wherein said altering reduces the expiration period by producing a predetermined number of pulses at a programmable rate, which is faster than the fixed rate by a factor of m/n.

26. The method as recited in claim 25, wherein said altering a pulse rate comprises:
receiving a first bit pattern from the processor to place the timing logic unit into a ‘no pulse’ state;
receiving a first control bit from the processor to place the timing logic unit into an ‘enable’ state;
receiving a plurality of second bit patterns, each different from the first bit pattern, from the processor to place the timing logic unit into a ‘pulse’ state multiple times; and
receiving a second control bit, different from the first control bit, from the processor to place the timing logic unit into a ‘disable’ state.

27. The method of claim 26, wherein the steps associated with said altering a pulse rate are repeated a number of times equal to the predetermined number divided by ‘m’.

28. A computer-usable carrier medium, comprising:
first program instructions executable on a computer system for enabling a timing logic unit of the computer system to generate one or more pulses;
second program instructions executable on the computer system for repeating the first program instructions upon receiving every n^{th} interrupt signal at a processor of the computer system, wherein ‘n’ is a programmable value selected from a group consisting of any positive, non-zero integer value, and wherein execution of the second program instructions cause the timing logic unit to generate a time expired signal.

29. The computer-usable carrier medium as recited in claim 28, wherein execution of the second program instructions increases or decreases an expiration period for completing a transaction cycle conducted between source and target devices coupled within or to the computer system.

30. The computer-usable carrier medium as recited in claim 29, wherein the expiration period is decreased by enabling the timing logic unit to generate more than one pulse for every n^{th} interrupt signal received by the processor.

31. The computer-usable carrier medium as recited in claim 29, wherein the expiration period is increased by enabling the timing logic unit to generate one pulse for every n^{th} interrupt signal received by the processor.

32. The computer-usable carrier medium as recited in claim 29, wherein the first program instructions are adapted to:
initialize the timing logic unit by generating a first bit pattern in a second counter of the timing logic unit;
enable the timing logic unit by setting one or more bits in a control register of the timing logic unit to a first logic level;
generate the one or more pulses by consecutively generating one or more second bit patterns, different from the first bit pattern, in the second counter of the timing logic unit; and

33. The computer-usable carrier medium as recited in claim 32, wherein the second program instructions are adapted to:
disable the timing logic unit by setting the one or more bits in the control register of the timing logic unit to a second logic level different from the first logic level; and
repeat the first program instructions by decrementing or incrementing a predetermined expiration value, which is stored within a time register of the timing logic unit, by the number of pulses generated during each repetition of the first program instructions, such that the first program instructions are repeated a number of times equal to the predetermined expiration value divided by the number of pulses generated per repetition.

34. The computer-usable carrier medium as recited in claim 33, wherein the computer-usable carrier medium comprises one or more buses within the computer system.

35. The computer-usable carrier medium as recited in claim 33, wherein the computer-usable carrier medium comprises a wired or wireless network interface for coupling the computer system to one or more additional computer systems.

36. The computer-usable carrier medium as recited in claim 33, wherein the computer-usable carrier medium comprises a memory device within the computer system.
